(19) United States
(12) Patent Application Publication
(10) Pub. No.: US 2017/0241792 A1
(43) Pub. Date: Aug. 24, 2017

(54) ROUTE AQUISITION SYSTEM, METHOD, AND PROGRAM

(71) Applicant: AISIN AW CO., LTD., Anjo-shi, Aichi-ken (JP)

(72) Inventors: Kenji NAGASE, Okazaki (JP); Kazuya INABA, Ichinomiya (JP); Yuhei GOSHI, Okazaki (JP); Motohiro NAKAMURA, Okazaki (JP); Kazunori WATANABE, Okazaki (JP)

(73) Assignee: AISIN AW CO., LTD., Anjo-shi, Aichi-ken (JP)

(21) Appl. No.: 15/519,712

(22) PCT Filed: Nov. 19, 2015
(86) PCT No.: PCT/JP2015/082520

§ 371 Date: Apr. 17, 2017

(30) Foreign Application Priority Data
Nov. 26, 2014 (JP) 2014-238322

(51) Int. Cl. G01C 21/34; G09B 29/00; G09B 29/10

(52) U.S. Cl. CPC G01C 21/3484; G01C 21/343; G09B 29/10; G09B 29/008

(57) ABSTRACT

Route acquisition systems, methods, and programs receive input of a plurality of destination locations and acquire a visit history that indicates a history of visit locations visited previously together with an order of visit to the visit locations. The systems, methods, and programs refer to the visit history which includes the visit locations which match the plurality of destination locations, set an order of visit to the plurality of destination locations on a basis of the order of visit to the visit locations which is indicated in the visit history, and acquire a route for visit to the plurality of destination locations.

### TECHNICAL FIELD

Related technical fields include route acquisition systems, methods, and programs for acquisition of a route to destination locations.

### BACKGROUND

There has hitherto been known a technique of exploring for a route for visiting a plurality of destination locations (a final destination location and intermediate destination locations) to provide route guidance or the like. For example, Japanese Patent Application Publication No. 2013-101051 (JP 2013-101051 A) discloses a technique of selecting an intermediate destination location on the basis of a departure location, the final destination location, and the passing frequency of each location. There also exists a technique of setting the order of visit to a plurality of destination locations by allowing a user himself/herself to input the order of visit.

### SUMMARY

With the techniques according to the related art, it has been difficult to acquire a route for visiting destination locations in accordance with an order of visit that matches a behavior pattern of the user. In a scene where a plurality of destination locations are to be visited, there is often a particular behavior pattern for the order of the destination locations to be visited by the user. For example, in the course of delivery to a certain destination location, and in the case where it is necessary to visit a different destination location to receive a baggage and to thereafter visit a final destination location, it is necessary to visit the different destination location first. Meanwhile, a user who purchases clothing and food at different destination locations occasionally desires to purchase food after purchasing clothing in order for quality preservation or the like of fresh food.

Further, with a configuration in which the user himself/herself inputs an order of visit, it is necessary for a user to decide and input an order of visit that matches his/her own behavior pattern each time a route is acquired, which complicates input operations.

Exemplary embodiments of the broad inventive principles described herein address the foregoing problem, and therefore have an object to automatically acquire a route for visiting destination locations in accordance with an order of visit that matches a behavior pattern of a user.

Exemplary embodiments provide route acquisition systems, methods, and programs that receive input of a plurality of destination locations and acquire a visit history that indicates a history of visit locations visited previously together with an order of visit to the visit locations. The systems, methods, and programs refer to the visit history which includes the visit locations which, match the plurality of destination locations, set an order of visit to the plurality of destination locations on a basis of the order of visit to the visit locations which is indicated in the visit history, and acquire a route for visit to the plurality of destination locations.

That is, with the route acquisition system, method, and program, an order of visit to a plurality of destination locations is acquired on a basis of a previous order of visit indicated in a visit history, and a route for visit to the plurality of destination locations is acquired. With this configuration, it is possible to set an order of visit to the destination locations by the user on the basis of the previous order of visit to the visit locations by the user. Thus, it is possible to acquire a route for visit while considering that the user desires to visit the current destination locations in accordance with an order that is the same as or similar to the previous order of visit. In the process described above, in addition, it is not necessary for the user to input the plurality of destination locations in consideration of the order of visit. As a result, it is possible to acquire a route for visiting the destination locations in accordance with an order of visit desired by the user, and to automatically acquire a route for visiting the destination locations in accordance with an order of visit that matches the behavior pattern of the user.

### BRIEF DESCRIPTION OF THE DRAWINGS

FIG. 1 is a block diagram of a navigation system that includes a route acquisition system.

FIG. 2 is a flowchart illustrating a route guidance process.

FIG. 3A illustrates an example of locations and FIGS. 3B to 3D schematically illustrate a history of routes that start at a departure location and reach a final destination location by way of intermediate destination locations.

FIGS. 4A to 4C schematically illustrate a history of routes that start at a departure location and reach a final destination location by way of intermediate destination locations.

FIGS. 5A to 5C schematically illustrate an example of acquisition of routes that start at a departure location and reach a final destination location by way of intermediate destination locations.

### DETAILED DESCRIPTION OF EXEMPLARY EMBODIMENTS

Hereinafter, embodiments will be described in the following order:

(1) Configuration of Navigation System

(2) Route Guidance Process

(3) Other Embodiments

### (1) Configuration of Navigation System

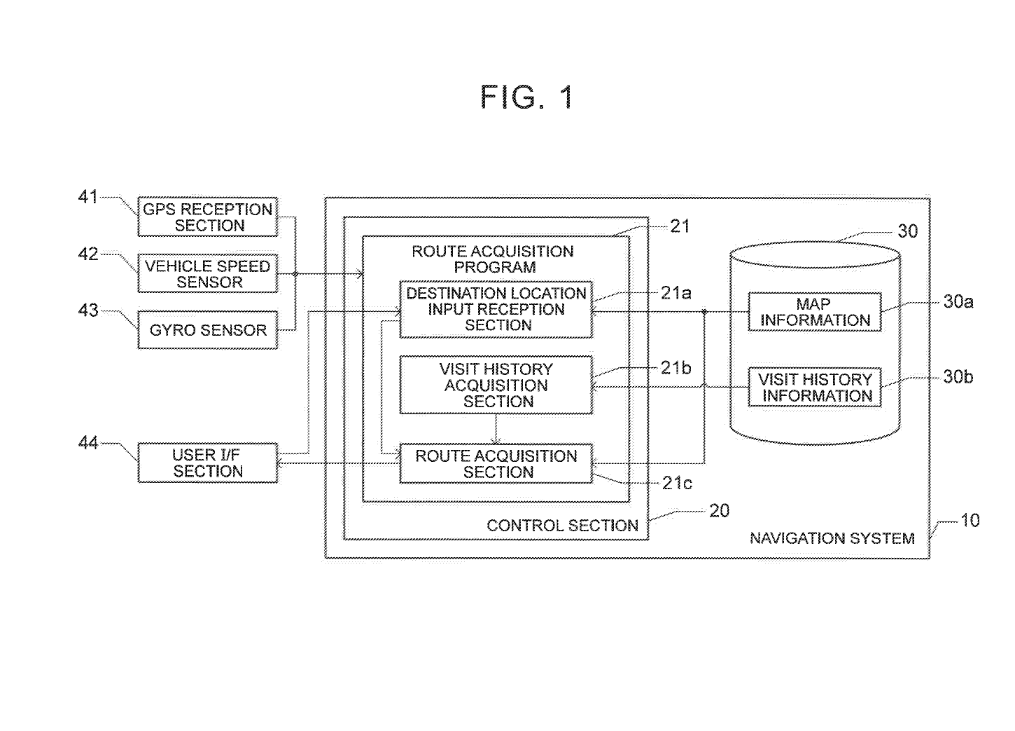

FIG. 1 is a block diagram illustrating the configuration of a navigation system 10 that includes a route acquisition system. The navigation system 10 includes a control section 20 that includes a CPU, a RAM, a ROM, and so forth, and a storage medium 30. The control section 20 can execute programs stored in the storage medium 30 and the ROM. (As used herein, the term “storage medium” is not intended to encompass transitory signals.) In the embodiment, the programs include a route acquisition program 21 and a navigation program (not illustrated).

Through processing performed by the navigation program, the control section 20 can acquire the current position of a vehicle, acquire a route from a departure location to a destination location (or a plurality of destination locations), and execute a function of guiding a user along the route. The navigation program includes a variety of program modules, which include the route acquisition program 21. The route acquisition program 21 includes a function of acquiring a route for visiting a plurality of destination locations after leaving a departure location in the case where the destination locations are input by the user. The route acquisition program 21 is executed when the user acquires a route while the navigation program is being executed.

The storage medium 30 stores map information 30a in advance. The map information 30a is information utilized to explore for a route and specify the position of the vehicle, and includes node data that indicate the positions of nodes set on roads on which the vehicle travels, shape interpolation point data that indicate the positions of shape interpolation points for specifying the shape of the roads between the nodes, link data that indicate coupling between the nodes, feature data that indicate the positions, the attributes (such as the name and the genre of shops (music software shop, clothing shop, bookstore, convenience store)), etc. of features that exist on or around the roads, and so forth. Such features may be destination locations. In addition, the link data are correlated with a link cost of a road section indicated by each link.

Further, visit history information 30b that enables reproduction of an order of visit to visit locations is accumulated in the storage medium 30 in the course of operation of the navigation system 10. The visit history information 30b includes a history of the current position of the vehicle, and is defined with positions passed and times at which the positions are passed correlated with each other every predetermined time during one travel (a travel from a departure location to a final destination location). Further, each history is correlated with the positions of destination locations (a final destination location and intermediate destination locations) visited by the user in the course of one travel. Thus, by referring to the visit history information 30b, the control section 20 can specify a route from the departure location to the final destination location and locations visited before the final destination location is reached as visit locations, and specify the order of visit to the visit locations.

In the embodiment, in order to implement the functions of the navigation program, the vehicle includes a GPS reception section 41, a vehicle speed sensor 42, a gyro sensor 43, and a user I/F section 44. The GPS reception section 41 receives radio waves from GPS satellites to output a signal for calculating the current position of the vehicle via an interface (not illustrated). The vehicle speed sensor 42 outputs a signal corresponding to the rotational speed of wheels of the vehicle. The control section 20 acquires the signal via an interface (not illustrated) to acquire the vehicle speed. The gyro sensor 43 detects the angular acceleration of gyration of the vehicle in a horizontal plane to output a signal corresponding to the direction of the vehicle. The control section 20 acquires the signal to acquire the travel direction of the vehicle. The control section 20 acquires the current position of the vehicle by specifying the travel track of the vehicle on the basis of an output signal from the vehicle speed sensor 42, the gyro sensor 43, and so forth. An output signal from the GPS reception section 41 is utilized to correct, for example, the current position of the vehicle which is specified by the vehicle speed sensor 42, the gyro sensor 43, and so forth.

The user I/F section 44 is an interface section that receives input of a command from a driver and that provides various kinds of information to the driver, and includes a sound input section, a display section such as a touch panel display, a switch, a speaker, and so forth (not illustrated). In the embodiment, the user can input a destination location utilizing the sound input section or the touch panel. That is, the control section 20 can analyze the content of a speech on the basis of a voice input to the sound input section, and acquire information that indicates a destination location. In addition, the control section 20 can acquire information that indicates a destination location on the basis of information input to the touch panel.

In the embodiment, in the case where a plurality of destination locations are input by the user, the control section 20 acquires a route for visit for visiting the destination locations in accordance with an order of visit that matches the taste of the user. In order to implement a process of acquiring the route for visit, the route acquisition program 21 includes a destination location input reception section 21a, a visit history acquisition section 21b, and a route acquisition section 21c.

The destination location input reception section 21a is a program module that causes the control section 20 to implement a function of receiving input of a plurality of destination locations. In the embodiment, the user can distinguish a final destination location and intermediate destination locations, which are included in the plurality of destination locations, from each other. In the case where a final destination location and intermediate destination locations are distinguished from each other, the user inputs the final destination location, and further inputs the intermediate destination locations to be passed in the course of traveling from the departure location (current position) to the final destination location, using the sound input section or the touch panel of the user I/F 44. In the case where a final destination location and intermediate destination locations are not distinguished from each other, the user inputs a plurality of destination locations using the sound input section or the touch panel of the user I/F 44. In either case, when a plurality of destination locations are input, the control section 20 specifies search target destination locations on the basis of an output signal output from the sound input section or the touch panel in accordance with the input content. Specifically, the user often inputs a part (such as a part of the name of a convenience store and a part of the name of a branch store, or the genre of a shop and a part of the name of an area in which the shop exists, for example) of information that indicates destination locations through speech or touch input, and therefore the control section 20 specifies destination locations correlated with the input part of information as the search target destination locations.

Further, the control section 20 refers to the map information 30a to search for a search target destination location. That is, the control section 20 refers to the feature data in the map information 30a to determine whether or not there exists a feature correlated with the part of information which is input by the user. In the case where the search target destination location exists in the map information 30a, the control section 20 considers that the search target destination location is the destination location which is input by the user. In the case where the search target destination location does not exist, the control section 20 may prompt the user for reentry, or may extract information on a different feature that is similar to the input part of information from the map information 30a and ask the user whether or not the extracted feature is correct.

In either case, through processing performed by the destination location input reception section 21a, the control section 20 receives a plurality of destination locations input by the user. In the embodiment, the control section 20 may be configured to allow the user to designate an order of visit when the control section 20 receives input of a plurality of destination locations. In this case, the user designates an order of visit to some or all of the destination locations utilizing the sound input section or the touch panel of the user I/F 44. When an order of visit is designated by the user, the control section 20 sets a route for visit without varying the designated order of visit in the process performed by the route acquisition section 21c to be discussed later. For destination locations, the order of visit to which is not designated by the user, the control section 20 considers that the order of visit is variable, and sets a route for visit. In the embodiment, it is assumed that the user does not designate an order of visit. That is, the control section 20 does not consider the order in which the destination locations are input as the order of visit. This is because, if the user is always required to input a plurality of destination locations through speech or the like in accordance with the order of visit, the trouble of input work is increased and, in the case where the user makes a mistake in the input order, the user must input the plurality of destination locations all over again in order to correct the input content.

The visit history acquisition section 21b is a program module that causes the control section 20 to implement a function of acquiring a visit history that indicates a history of visit locations visited previously together with the order of visit to the visit locations. That is, by acquiring the visit history information 30b in which positions and times at which the positions are passed are correlated with each other and which are correlated with the positions of destination locations visited by the user in the course of travel, the control section 20 acquires a visit history that indicates a history of visit locations visited previously together with the order of visit to the visit locations.

The route acquisition section 21c is a program module that causes the control section 20 to implement a function of setting an order of visit to a plurality of destination locations on the basis of an order of visit and acquiring a route for visit to the plurality of destination locations. In the embodiment, the control section 20 sets an order of visit on the basis of the order of visit which is indicated in the visit history information 30b such that the order of visit to the destination locations is as close as possible to (the same as or similar to) the previous order of visit to the visit locations (as discussed in detail later). That is, the control section 20 acquires a route for visiting a plurality of destination locations in accordance with an order of visit that is as close as possible to the visit history in the course of traveling along a route that reaches the destination locations.

With the configuration described above, the control section 20 can set an order of visit to the destination locations by the user on the basis of the previous order of visit to the visit locations by the user. Thus, it is possible to acquire a route for visit while considering that the user desires to visit the current destination locations in accordance with an order that is the same as or similar to the previous order of visit, and possible to acquire a route for visiting the destination locations in an order of visit desired by the user. In addition, the control section 20 can automatically acquire a route for visiting the destination locations in accordance with an order of visit that matches the behavior pattern of the user.

When a route for visit is acquired as described above, through processing performed by the navigation program, the control section 20 provides guidance on the route for visit. That is, the control section 20 acquires the current position of the vehicle on the basis of the signals output from the GPS reception section 41, the vehicle speed sensor 42, and the gyro sensor 43, and sets the display range of a map such that the current position of the vehicle is at a predetermined position on the display section. The control section 20 superimposes an image that indicates the current position on an image that indicates the map in the display range, and further generates an image in which the route for visit is highlighted. The control section 20 outputs information that indicates the generated image to the display section of the user I/F 44. In addition, the control section 20 repeatedly performs this process each predetermined period (e.g. every 100 ms). As a result, the display section of the user I/F 44 displays the route while successively updating the content of the map being displayed in accordance with the current position of the vehicle. The user can drive the vehicle as he/she receives guidance on the route for reaching the plurality of destination locations through the map. Thus, it is possible for the user to visit the destination locations in accordance with an order of visit desired by the user by driving the vehicle in accordance with the guidance.

### (2) Route Guidance Process

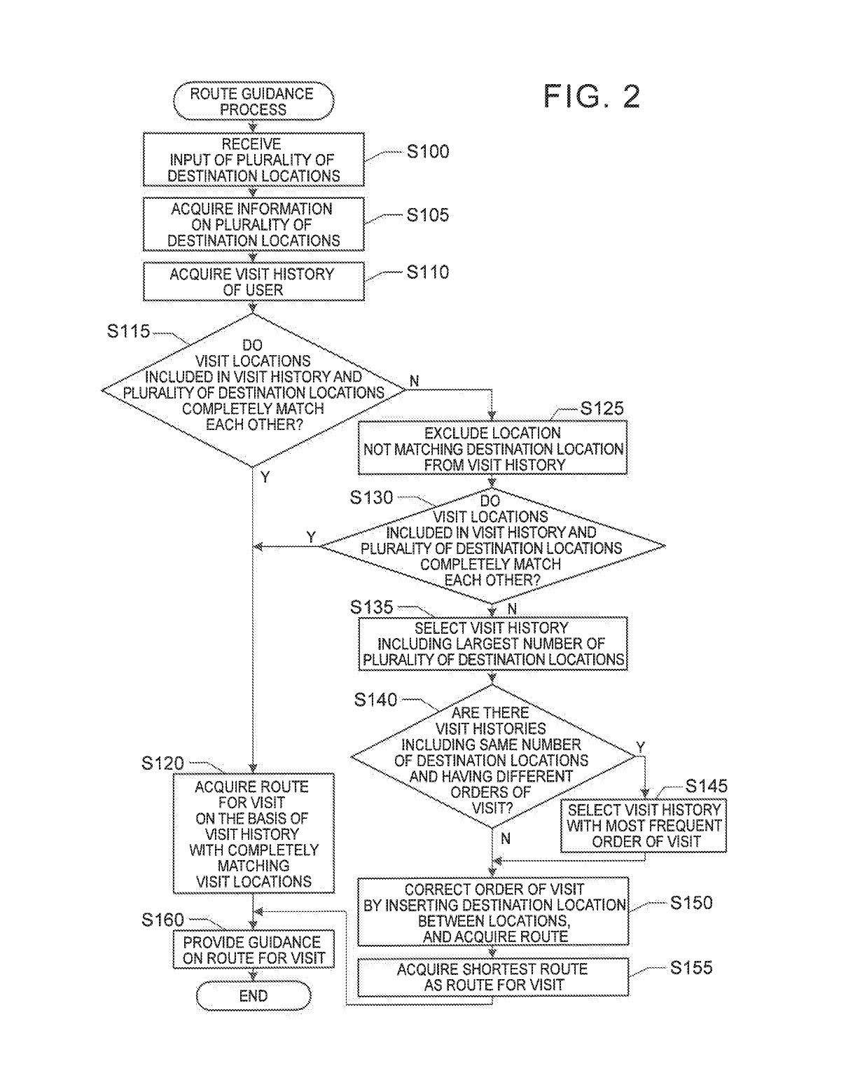

Next, a route guidance process performed by the route acquisition program 21 and the navigation program will be described. In the embodiment, in the case where the user operates the user I/F 44 to provide an instruction to start providing guidance on a route to a plurality of destination locations, the control section 20 executes the route guidance process illustrated in FIG. 2. When the route guidance process is started, through processing performed by the destination location input reception section 21a, the control section 20 receives input of a plurality of destination locations (step S100). That is, the control section 20 outputs a control signal to the display section of the user I/F 44, and displays an indication that prompts the user to input a plurality of destination locations. When the user inputs a plurality of destination locations (in the case where a distinction of destination locations is made, a final destination location and intermediate destination locations) using the sound input section or the touch panel of the user I/F 44, the control section 20 specifies the plurality of destination locations which are input by the user by specifying search target destination locations on the basis of an output signal from the sound input section or the touch panel of the user I/F 44 and searching the map information 30a for the search target destination locations.

When the plurality of destination locations are specified, through processing performed by the destination location input reception section 21a, the control section 20 acquires information on the plurality of destination locations (step S105). That is, the control section 20 refers to the map information 30a to acquire information correlated with each of the plurality of destination locations. Such information may be information that allows uniquely specifying each of the destination locations, and may be constituted of information that indicates the position of the destination location or an ID. In the embodiment, the control section 20 acquires information that indicates the position as information correlated with each of the plurality of destination locations.

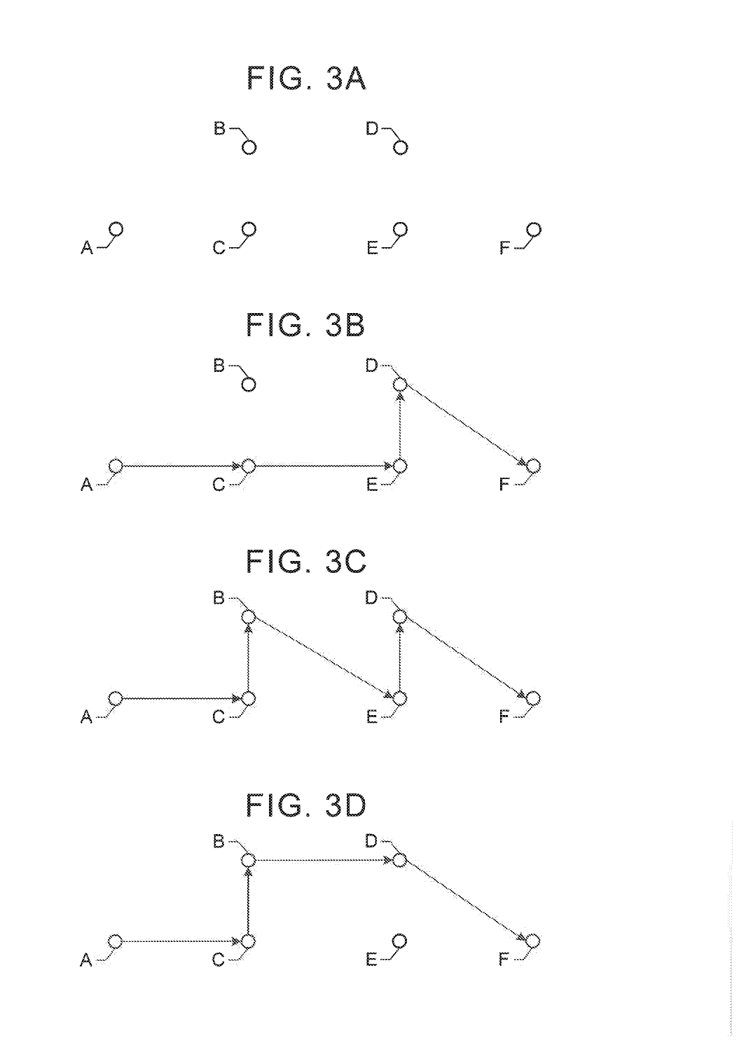

A specific example will be described using the example illustrated in FIG. 3A. In FIG. 3A, locations A to F are indicated by circles, with the locations B, C, D, and E being features of different genres (such as the location B being a music software shop, the location C being a clothing shop, the location D being a convenience store, and the location E being a bookstore, for example). In this example, if the user starts a process of inputting a plurality of destination locations when the current position is the location A, the location A is determined as the departure location. Here, it is further assumed that, in the example described above, the user inputs the location F as the final destination location and inputs the locations C, D, and E as intermediate destination locations. In the case where a distinction of destination locations is not made, the locations C, D, E, and F are determined as destination locations, and the location F is not necessarily the last in the order of visit. A description will be made here, however, using the example in which the location F is determined as the final destination location.

Next, through processing performed by the visit history acquisition section 21b, the control section 20 acquires a visit history of the user (step S110). That is, the control section 20 refers to the storage medium 30 to acquire the visit history information 30b. For example, in the case where the user has previously adopted a route that starts at the departure location A and reaches the location F by way of the locations C, E, and D as illustrated in FIG. 3B, a history of such a route is stored in the storage medium 30 as the visit history information 30b. When the control section 20 acquires the visit history information 30b, the acquired information is stored in the RAM, which allows analyzing the positions of and the order of visit to the destination locations in the history which is indicated in FIG. 3B. As a matter of course, the visit history information 30b is increased in the course of travel of the vehicle. Therefore, when the visit history information 30b is acquired, each of travel histories for a plurality of times of travel can be analyzed.

Next, through processing performed by the route acquisition section 21c, the control section 20 determines whether or not the visit locations which are included in the visit history and the plurality of destination locations completely match each other (step S115). That is, the control section 20 refers to each of the visit histories which are acquired in step S110 to determine whether or not the departure location and the plurality of visit locations match the current departure location and the plurality of destination locations, respectively. In the embodiment, whether or not locations match each other is determined on the basis of whether or not the positions of the locations match each other (whether or not the difference between the positions of the locations is equal to or less than a predetermined threshold). In the case where there exists a visit history that includes a departure location and a plurality of visit locations that completely match the current departure location and the plurality of destination locations, respectively, the control section 20 determines that the visit locations which are included in the visit history and the plurality of destination locations completely match each other.

Here, a case where the user inputs the location F as the final destination location and inputs the locations C, D, and E as intermediate destination locations is assumed. Therefore, in the case where there exists a visit history that starts at the departure location A and reaches the location F by way of the locations C, E, and D as illustrated in FIG. 3B, the control section 20 determines that the visit locations which are included in the visit history and the plurality of destination locations completely match each other.

In the case where it is determined in step S115 that the visit locations which are included in the visit history and the plurality of destination locations completely match each other, then through processing performed by the route acquisition section 21c, the control section 20 acquires a route for visit on the basis of the completely matching visit history (step S120). In the embodiment, the completely matching visit history includes not only the same destination location but also the same departure location, and therefore the control section 20 acquires a route indicated in the visit history which is determined as completely matching as the current route for visit. For example, in the case where the visit history which is determined as completely matching is the visit history illustrated in FIG. 3B, routes between the locations schematically indicated by the solid arrows in FIG. 3B are acquired as the current route for visit. When the user is to visit the intermediate destination locations, and if the user has previously visited the same intermediate destination locations in accordance with a particular order of visit, it is reasonable to presume that the user desires to visit the destination locations in accordance with the same order of visit again, rather than in accordance with an order that is different from the previous order of visit. Thus, by acquiring a route for visit on the basis of a visit history as in the embodiment, it is possible to acquire a route for visiting a plurality of destination locations in accordance with an order of visit that matches the need of the user.

On the other hand, in the case where it is not determined in step S115 that the visit locations which are included in the visit history and the plurality of destination locations completely match each other, then through processing performed by the route acquisition section 21c, the control section 20 excludes a location that does not match a destination location from the visit history (step S125). That is, the control section 20 specifies a location that is different from the plurality of destination locations which are input by the user in the visit history which is acquired in step S110, and excludes the location.

FIG. 3C illustrates a visit history for a case where the user previously adopted a route that started at the departure location A and reached the location F by way of the locations C, B, E, and D. FIG. 3D illustrates a visit history for a case where the user previously adopted a route that started at the departure location A and reached the location F by way of the locations C, B, and D. In the case where these visit histories are stored in the storage medium 30 as the visit history information 30b, the visit location B in these histories does not match the intermediate destination locations (locations C, D, and E). Thus, in the case where step S125 is executed, the control section 20 excludes the location B from these histories.

Next, for the visit history after being processed in step S125, the control section 20 determines whether or not the visit locations which are included in the visit history and the plurality of destination locations completely match each other (step S130). That is, the same process as the process in step S115 is performed on the visit history after being processed in step S125. Then, in the case where it is determined in step S130 that the visit locations which are included in the visit history and the plurality of destination locations completely match each other, the control section 20 executes step S120. That is, a route for visit is acquired on the basis of the visit history after being processed in step S125. For example, in the case where the visit histories illustrated in FIGS. 3C and 3D are present, visit locations in a visit history obtained by excluding the location B from the visit history illustrated in FIG. 3C are the same as the visit locations in the visit history illustrated in FIG. 3B. Thus, in this case, the control section 20 acquires a route for visit on the basis of a visit history obtained by excluding the location B.

The visit history illustrated in FIG. 3C described above is a visit history that includes the plurality of destination locations (the intermediate destination locations C, E, and D and the final destination location F) and a different location (location B) as visit locations. Thus, with the process discussed above, in the case where there exists a visit history that includes the plurality of destination locations and the different location as visit locations, the control section 20 sets an order obtained by excluding the different location from the order of visit to the visit locations which is indicated in the visit history as the order of visit to the plurality of destination locations, and acquires a route for visit. That is, in the case where the visit locations which are visited in a previous visit history exceed the current plurality of destination locations in number and include all of the plurality of destination locations, the plurality of destination locations and the visit locations can be caused to completely match each other by excluding a different location, which is not included in the plurality of destination locations, from the visit history. Thus, by acquiring a route for visit on the basis of the visit history after the exclusion, it is possible to acquire a route for visiting the plurality of destination locations in accordance with an order of visit that matches the need of the user.

In the case where it is not determined in step S130 that the visit locations which are included in the visit history and the plurality of destination locations completely match each other, a visit history that includes the largest number of the plurality of destination locations is selected (step S135). That is, the control section 20 makes a comparison between the visit locations which are included in each of the visit histories which are acquired in step S110 (in the case where the process in step S125 has been performed, the visit histories after being processed) and the plurality of destination locations which are acquired in step S105, and in the case where the visit locations and the plurality of destination locations match each other, executes a process of incrementing the number of matching locations for each of the visit histories. Then, the control section 20 selects a visit history with the largest number of matching locations as a visit history that includes the largest number of the plurality of destination locations.

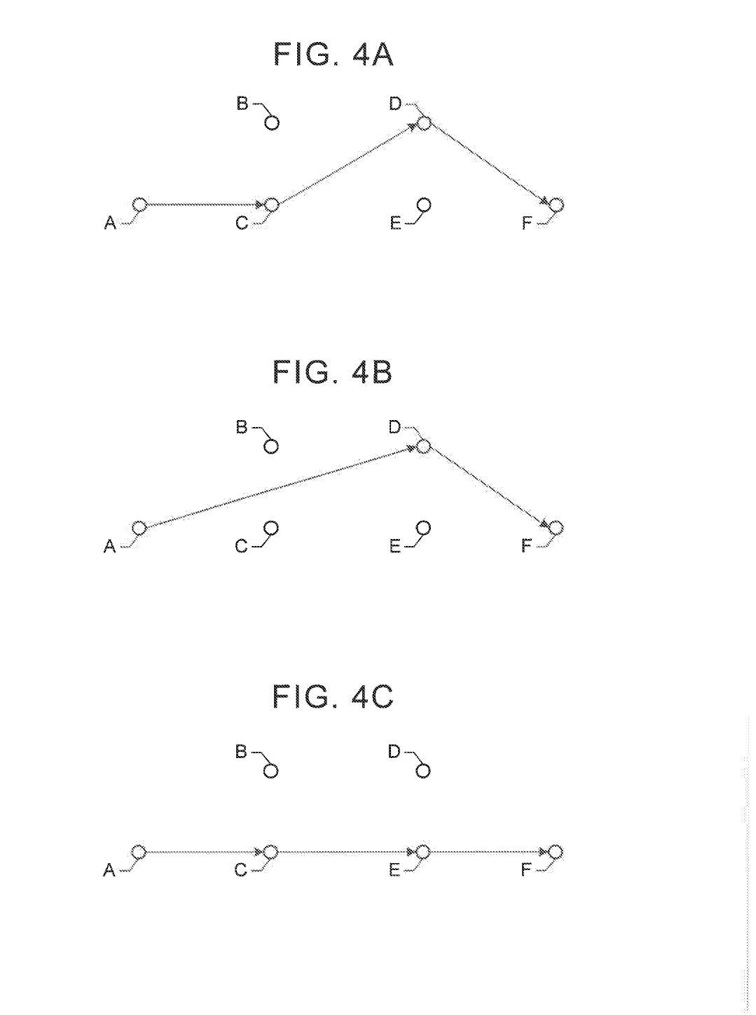

For example, in the case where the visit history of FIG. 3C discussed above is not present and the visit history of FIG. 3D) is present in the visit history information 30b, step S135 is executed after the determination in step S130. In this case, the location B is excluded from the visit locations illustrated in FIG. 3D, and thus the location B has been excluded in the visit history after being processed as illustrated in FIG. 4A. In this case, the control section 20 considers that the order of visit in the visit history after being processed is the order of visit after excluding the location. Thus, after the visit history of FIG. 3D is processed, the order of visit includes the locations A, C, D, and F as illustrated in FIG. 4A.

Here, further, it is assumed that the visit histories illustrated in FIGS. 4B and 4C have been acquired in step S110. FIG. 4B illustrates a visit history for a case where the user previously adopted a route that started at the departure location A and reached the location F by way of the location D. FIG. 4C illustrates a visit history for a case where the user previously adopted a route that started at the departure location A and reached the location F by way of the locations C and E.

As described above, when step S135 is executed on the visit histories illustrated in FIGS. 4A, 4B, and 4C, the control section 20 considers that two visit locations (locations C and D) in the visit history illustrated in FIG. 4A match the intermediate destination locations. In addition, the control section 20 considers that one visit location (location D) in the visit history illustrated in FIG. 4B matches the intermediate destination locations, and considers that two visit locations (locations C and E) in the visit history illustrated in FIG. 4C match the intermediate destination locations. Thus, the control section 20 selects the visit histories illustrated in FIGS. 4A and 4C as the visit history which includes the largest number of the plurality of destination locations.

Next, through processing performed by the route acquisition section 21c, the control section 20 determines whether or not there exist visit histories that include the same number of destination locations and that have different orders of visit (step S140). For example, in the case where the visit histories illustrated in FIGS. 4A and 4C are selected in step S135, the number of destination locations included in each of the visit histories is the same at two, and therefore the control section 20 determines that there exist visit histories that include the same number of destination locations and that have different orders of visit.

In the case where it is determined in step S140 that there exist visit histories that include the same number of destination locations and that have different orders of visit, then through processing performed by the route acquisition section 21c, the control section 20 selects a visit history with the most frequent order of visit (step S145). That is, visit histories are accumulated in the course of travel of the vehicle, and therefore a plurality of visit histories with the same order of visit are occasionally accumulated. For example, there are occasionally a plurality of visit histories that have been subjected to the processes in steps S110, S125, and S135 and that indicate visits to the same visit locations. In this case, it can be considered that the most frequent visit history best matches the taste of the user. Thus, the control section 20 selects a visit history with the most frequent order of visit.

For example, in the case where the visit histories illustrated in FIGS. 4A and 4C are selected in step S135, and if the visit history illustrated in FIG. 4A has been adopted 30 times by the user and the visit history illustrated in FIG. 4C has been adopted 15 times by the user, the control section 20 selects the visit history illustrated in FIG. 4A in step S145. In the case where it is not determined in step S140 that there exist visit histories that include the same number of destination locations and that have different orders of visit, there is one visit history (one visit history with the same order of visit) selected in step S135, and therefore the one visit history is selected.

Next, through processing performed by the route acquisition section 21c, the control section 20 corrects the order of visit by inserting a destination location between locations, and acquires a route (step S150). That is, the control section 20 corrects the order of visit to the visit locations by adding an intermediate destination location not included in the visit history which is selected in step S135 or S145 between locations in the visit history. For example, in a state in which the visit history illustrated in FIG. 4A is selected, the intermediate destination location E is not included in the visit history, and therefore the control section 20 makes a correction by inserting the location E between the locations A and C, a correction by inserting the location E between the locations C and D, and a correction by inserting the location E between the locations D and F, respectively, in the visit history illustrated in FIG. 4A. In this way, all the destination locations and the order of visit are decided when a correction is made to add a destination location between locations.

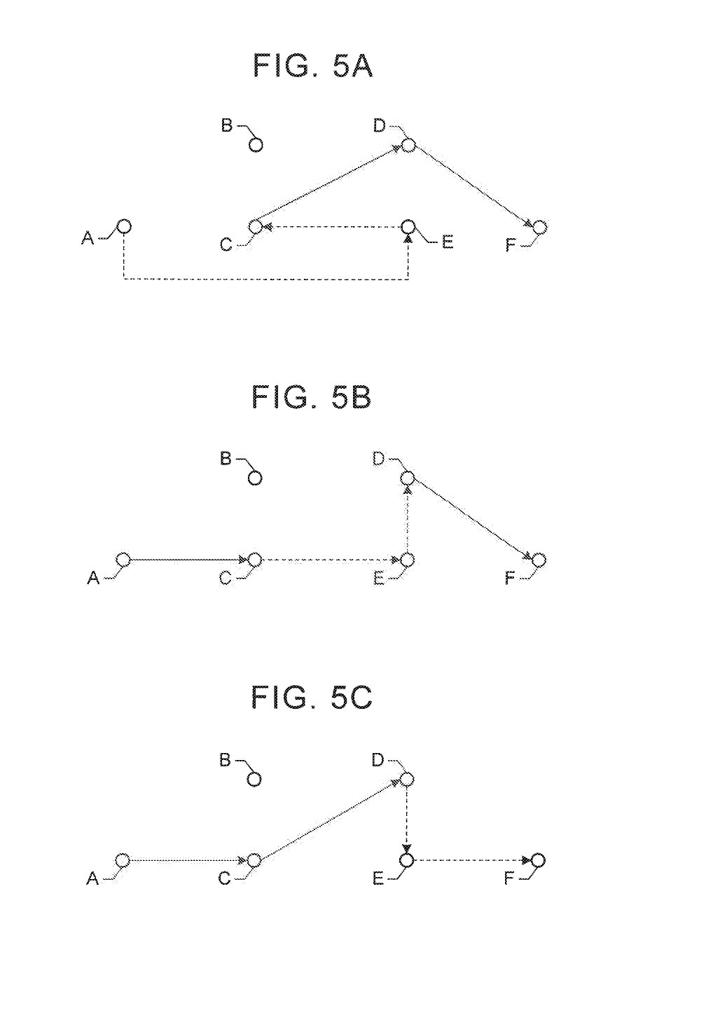

Then, the control section 20 refers to the map information 30a, and explores for a route for the corrected portion to acquire a route for visiting the locations in accordance with the corrected order. The route is specified by the control section 20 by exploring for a route that connects the corrected locations on the basis of the map information 30a and using the route which is indicated in the visit history information 30b for a route that connects the non-corrected locations. FIGS. 5A, 5B, and 5C schematically illustrate a route acquired after making the correction by inserting the location E between the locations A and C, the correction by inserting the location E between the locations C and D, and the correction by inserting the location E between the locations D and F, respectively, in the visit history illustrated in FIG. 4A. In FIGS. 5A, 5B, and 5C, a route generated by the correction is indicated by the broken arrows.

Next, through processing performed by the route acquisition section 21c, the control section 20 acquires the shortest route as the route for visit (step S155). That is, the control section 20 acquires a route, the total distance of which is the shortest, as the route for visit from among the routes for visiting the plurality of destination locations in accordance with the corrected orders. That is, an ordinary user often desires a short-distance route from the viewpoint of the amount of energy consumption, the time required, and so forth. Thus, the control section 20 acquires a route, the total distance of which is the shortest, as the route for visit from among the routes for visiting the plurality of destination locations in accordance with the corrected orders. As a result, a route that matches the need of the user can be used as the route for visit.

When a route for visit is acquired as described above, then through processing performed by the navigation program, the control section 20 provides guidance on the route for visit (step S160). That is, the control section 20 outputs a map that indicates the route for visit to the display section of the user I/F 44. The user can drive the vehicle as he/she receives guidance on the route for reaching the plurality of input destination locations through the map, and can visit the destination locations in accordance with the order of visit which is desired by the user.

### (3) Other Embodiments

The embodiment described above is an example, and a variety of other embodiments can be adopted. For example, the navigation system 10 may be permanently mounted on a vehicle C, or may be implemented as a portable terminal that can be brought into the vehicle C to be utilized. The navigation system 10 which is implemented as a portable terminal may be utilized by a pedestrian, or may be utilized by a passenger of a different vehicle (such as a bicycle).

Further, some of the functions of the destination location input reception section 21a, the visit history acquisition section 21b, and the route acquisition section 21c may be implemented by a control subject that is different from that in the embodiment discussed above. For example, the visit history information 30b may be managed by an external information management server or the like, and the information management server may implement the visit history acquisition section 21b and a part of the route acquisition section 21c. That is, the navigation system 10 may receive input of a destination location, the destination location may be transmitted to the information management server, a route acquired by the information management server on the basis of the destination location may be transmitted to the navigation system 10, and the navigation system 10 may provide guidance.

The destination location input reception means may only be able to receive input of a plurality of destination locations. That is, in the case where the user desires to visit a plurality of destination locations, the user inputs the plurality of destination locations using desired input means (such as speech recognition for recognizing the content of a speech or character input, for example), and the destination location input reception means receives the input plurality of destination locations. A variety of input modes can be assumed as the mode of input of the destination location. For example, the position of the destination location may be input, or the attribute (name, branch store name, type (genre)) of the destination location may be input. Alternatively, the action purpose (such as eating, shopping, and watching a play, for example), rather than the destination location, may be input to indirectly input the destination location. In the embodiment discussed above, a final destination location and intermediate destination locations are distinguished from each other. However, a final destination location and intermediate destination locations may not be distinguished from each other.

The visit history acquisition means may only be able to acquire a visit history that indicates a history of visit locations visited previously together with the order of visit to the visit locations. That is, information that enables reproduction of the order of visit to the visit locations may be defined as a visit history, and the visit history may be acquired. The visit history may indicate at least visit locations and the order of visit to the visit locations, and may also include a route utilized to visit the visit locations. In this case, a route utilized previously can also be reproduced in addition to the order of visit.

The route acquisition means may only be able to set the order of visit to a plurality of destination locations on the basis of the order of visit, and acquire a route for visit to the plurality of destination locations. That is, the route acquisition means may only be able to set the order of visit to a plurality of destination locations on the basis of the order of visit which is indicated in the visit history such that the order of visit to the current destination locations is as close as possible to (the same as or similar to) the previous order of visit to the visit locations.

The route for visit may be set on the basis of the visit history, may be acquired by exploring for a new route for visit for visiting the plurality of destination locations, and may be obtained by a combination of both. For example, it may be configured that in the case where the visit history includes a route that includes a visit to the visit locations, a part or all of the route can be adopted as the current route to the plurality of destination locations. In the case where only a part of a route for visit for visiting the plurality of destination locations is specified on the basis of the visit history, the remaining route for visit for visiting the destination locations may be specified through an exploration.

In the case where the visit history does not include a route in which the visit locations are visited, an exploration may be made for a route for visit for visiting a plurality of destination locations in accordance with an order of visit set on the basis of the order of visit which is indicated in the visit history. Further, in the case where an exploration for a route for visit is made without specifying the position of a destination location, and in a configuration in which the attribute of the destination location is input, for example, a comparison is made between the input attribute of the destination location and the attribute of the visit location in the visit history to decide the order of visit to the current destination locations. In this case, the route acquisition means searches the map information 30a for a destination location of the input attribute, and explores for a route for visit for visiting the destination locations in accordance with the order of visit. In the embodiment discussed above, further, visit histories that match the current departure location are referred to and analyzed. However, visit histories that do not have a matching departure location may be referred to. In this case, a route for a non-matching portion (a route from the current departure location to the first visit location) is acquired through an exploration.

As a configuration example for setting an order of visit to a plurality of destination locations on the basis of a visit history, a configuration may be adopted in which in the case where there exists a visit history that includes visit locations that completely match the plurality of destination locations, the route acquisition means sets an order of visit to the visit locations which is indicated in the visit history as the order of visit to the plurality of destination locations, and acquire a route for visit. That is, in the case where the visit locations which are visited previously and the current plurality of destination locations completely match each other, it is presumed that the user desires to visit the plurality of destination locations in accordance with an order that is the same as the previous order of visit to the visit locations. Thus, in the case where there exists a visit history that includes visit locations that completely match the plurality of destination locations, it is possible to acquire a route for visiting the plurality of destination locations in accordance with an order of visit that matches the need of the user by setting the order of visit to the visit locations which is indicated in the visit history as the order of visit to the plurality of destination locations.

In the case where there exist a plurality of visit histories that include the same visit locations and the orders of visit to the visit locations in the visit histories are different from each other, it is preferable to adopt the most frequent order of visit, and to acquire a route for visit for visiting the plurality of destination locations on the basis of the adopted order of visit. With this configuration, a route that is most likely to match the need of the user can be used as the route for visit.

Further, a configuration may be adopted in which in the case where there exists a visit history that includes the plurality of destination locations and the different location as visit locations, the route acquisition means sets an order obtained by excluding the different location from the order of visit to the visit locations which is indicated in the visit history as the order of visit to the plurality of destination locations, and acquire a route for visit. That is, in the case where the visit locations which are visited in a previous visit history exceed the current plurality of destination locations in number and include all of the plurality of destination locations, a different location, which is not included in the plurality of destination locations, is excluded from the visit history. When the different location is excluded from the visit history, the visit locations after the exclusion completely match the plurality of destination locations. As a result, the same process can be performed as in the case where there exists a visit history that includes visit locations that completely match the plurality of destination locations. Thus, by setting the order of visit to the visit locations after the exclusion as the order of visit to the plurality of destination locations, it is possible to acquire a route for visiting the plurality of destination locations in accordance with an order of visit that matches the need of the user.

Further, a configuration may be adopted in which in the case where there exist a plurality of visit histories that include visit locations that are some of the plurality of destination locations, the route acquisition means sets an order of visit to the plurality of destination locations on the basis of the most frequent one of the orders of visit which are indicated in the visit histories, and acquire a route for visit. That is, in the case where there exist a plurality of visit histories that include visit locations that are some of the plurality of destination locations, the need of the user is reflected even if a route for visit to the plurality of destination locations is acquired on the basis of any of the visit histories. However, an order that is more frequently used to visit the visit locations, among the orders of visit which are indicated in the visit histories, can be considered to better match the taste of the user. Thus, by setting the order of visit to the plurality of destination locations on the basis of the most frequent order, among the orders of visit which are indicated in the visit histories, and acquiring a route for visit, it is possible to acquire a route for visiting the plurality of destination locations in accordance with an order that matches the need of the user.

Further, in the case where there exists a visit history that includes visit locations that are some of the plurality of destination locations, the route acquisition means may be configured to correct the order of visit to the visit locations by adding a destination location not included in the visit history to the visit locations, and acquire a route, the total distance of which is the shortest, as the route for visit from among the routes for visiting the plurality of destination locations in accordance with the corrected orders. That is, in the case where there exists a visit history that includes visit locations that are some of the plurality of destination locations, all the destination locations and the order of visit are decided when the order of visit to the visit locations is corrected by adding a destination location not included in the visit history. In the case where the order of visit is corrected by adding a destination location to any position in the order of visit to the visit locations, however, there are assumed to be a plurality of orders in which the destination location can be added, and therefore there are assumed to be a plurality of orders of visit after the correction.

Then, a part of the previous order of visit has not been corrected in any of the orders of visit after the correction. Therefore, even if a route for visit is acquired on the basis of any of the orders of visit, it is possible to acquire a route for visiting the plurality of destination locations in accordance with an order that matches the need of the user. Thus, it is possible to adopt a configuration that adopts a configuration for deciding a route for visit with a focus placed on various elements. For example, an ordinary user often desires a short-distance route from the viewpoint of the amount of energy consumption, the time required, and so forth. Thus, through a configuration for acquiring a route, the total distance of which is the shortest, as the route for visit from among the routes for visiting the plurality of destination locations in accordance with the corrected orders, it is possible to obtain a route that better matches the need of the user as the route for visit.

Further, it is possible to consider that changing the visit history as little as possible matches the need of the user. In this case, the route acquisition means may be configured to acquire a route, the distance of a portion of which between locations in which the order of visit to the visit locations has not been corrected is the longest, as the route for visit from among the routes for visiting the plurality of destination locations in accordance with the corrected orders. With this configuration, a route, an unchanged portion of which is the longest and therefore a portion of which changed with respect to the visit history is the shortest and which is least affected by the correction, can be acquired as the route for visit. A route may be acquired on the basis of various elements. For example, there may be a configuration in which a route exploration is made on the basis of a cost set so as to become smaller as the distance of a portion of the route between locations in which the order of visit to the visit locations has not been corrected is longer and that becomes smaller as the total distance of the route is shorter.

Further, the technique of setting an order of visit to a plurality of destination locations on the basis of an order of visit to visit locations can also be implemented as a program or a method. The system, program, and method described above includes various aspects such as those implemented using a single device and those implemented utilizing parts that are common to various members provided in the vehicle. For example, a navigation system, method, and program that includes the system described above can be provided. Various changes may be made. For example, some units may be implemented using software, and the others may be implemented using hardware. Further, the above-described principles may be implemented as a storage medium for a program that controls the system. As a matter of course, the storage medium for the software may totally equally be a magnetic storage medium, a magneto-optical storage medium, or any storage medium that may be developed in the future.

1. A route acquisition system comprising:
an input that receives input of a plurality of destination locations;
a processor programmed to:
acquire a visit history that indicates a history of visit locations visited previously together with an order of visit to the visit locations;
refer to the visit history which includes the visit locations which match the plurality of destination locations;
set an order of visit to the plurality of destination locations on a basis of the order of visit to the visit locations which is indicated in the visit history; and
acquire a route for visit to the plurality of destination locations.

2. The route acquisition system according to claim 1, wherein the input receives input of an attribute of the destination location as input of the destination location.

3. The route acquisition system according to claim 2, wherein the processor is programmed to:
refer to the visit history which includes the visit location of an attribute that matches the attribute of the destination location.

4. The route acquisition system according to claim 1, wherein the processor is programmed to:
when the visit history includes the plurality of destination locations and a different location as the visit locations, the set an order obtained by excluding the different location from the order of visit to the visit locations which is indicated in the visit history as the order of visit to the plurality of destination locations.

5. The route acquisition system according to claim 1, wherein the processor is programmed to:
when there exist a plurality of the visit histories that include the visit locations which are some of the plurality of destination locations, set an order of visit to the plurality of destination locations on a basis of the most frequent order, of the orders of visit which are indicated in the visit histories.

6. The route acquisition system according to claim 1, wherein the processor is programmed to:
when the visit history includes the visit locations which are some of the plurality of destination locations, correct the order of visit to the visit locations by adding the destination location which is not included in the visit history to the visit locations; and
acquire a route, a total distance of which is the shortest, as the route for visit from among the routes for visiting the plurality of destination locations in accordance with the corrected orders.

7. The route acquisition system according to claim 1, wherein the processor is programmed to:
when the visit history includes the visit locations which are some of the plurality of destination locations, correct the order of visit to the visit locations by adding the destination location which is not included in the visit history to the visit locations; and
acquire a route, a distance of a portion of which between locations in which the order of visit to the visit locations has not been corrected is the longest, as the route for visit from among the routes for visiting the plurality of destination locations in accordance with the corrected orders.

8. The route acquisition system according to claim 1, wherein the processor is programmed to:
when the visit history includes the visit locations which completely match the plurality of destination locations, set an order of visit to the visit locations which is indicated in the visit history as the order of visit to the plurality of destination locations.

9. A route acquisition method comprising:
receiving input of a plurality of destination locations;
acquiring a visit history that indicates a history of visit locations visited previously together with an order of visit to the visit locations; and
referring to the visit history which includes the visit locations which match the plurality of destination locations;
setting an order of visit to the plurality of destination locations on a basis of the order of visit to the visit locations which is indicated in the visit history; and
acquiring a route for visit to the plurality of destination locations.

10. A computer-readable storage medium storing a computer-executable route acquisition program that causes a computer to implement the following functions:
receiving input of a plurality of destination locations;
acquiring a visit history that indicates a history of visit locations visited previously together with an order of visit to the visit locations;
referring to the visit history which includes the visit locations which match the plurality of destination locations;
setting an order of visit to the plurality of destination locations on a basis of the order of visit to the visit locations which is indicated in the visit history; and
acquiring a route for visit to the plurality of destination locations.
